(19) United States
(12) Patent Application Publication
(10) Pub. No.: US 2012/0327046 A1
(43) Pub. Date: Dec. 27, 2012

(54) STYLUS

(76) Inventor: Jamie Sung, Taichung City (TW)

(21) Appl. No.: 13/495,455

(22) Filed: Jun. 13, 2012

(30) Foreign Application Priority Data
Jun. 21, 2011 (TW) 100211278

(51) Int. Cl. G06F 3/033

(52) U.S. Cl. 345/179

(57) ABSTRACT

A stylus is adapted for inputting command to an electronic device and includes an electrically-conductive handle portion, an electrically-conductive contact portion adapted to contact the electronic device, and an electrically-conductive spring. The spring interconnects electrically the handle portion and the contact portion, and is resiliently flexible for permitting the handle portion to pivot relative to the contact portion when the contact portion contacts the electronic device.

### CROSS-REFERENCE TO RELATED APPLICATION

This application claims priority to Taiwanese Application No. 100211278, filed on Jun. 21, 2011.

### BACKGROUND OF THE INVENTION

1. Field of the Invention

The invention relates to a stylus, and more particularly to a stylus for inputting command to an electronic device.

2. Description of the Related Art

Referring to FIG. 1, a conventional stylus 1 is shown to include a stylus body 11 and a transparent conductive film 12 formed on the stylus body 11. The stylus body 11 has a handle portion 111 and a transparent touch portion 112 connected electrically to the handle portion 111. When the transparent touch portion 112 of the stylus 1 contacts a capacitive touch panel 2, a capacitance change would be generated via the conductive film 12 for determining the location of the contact on the touch panel 2. By virtue of the transparent touch portion 112, a user can precisely control the conventional stylus on the touch panel 2.

However, since the transparent touch portion 112 is configured to form a fixed angle relative to the main body 11, when the user holds the main body 1 to move the conventional stylus 1 on the touch panel 2, the transparent touch portion 112 may not maintain stable contact with the touch panel 2, thereby reducing the accuracy of the location-determining process.

Another conventional stylus for use on a capacitive touch panel includes a pen-shaped body and a panel-contact disc connected electrically to a nib of the pen-shaped body. However, the joint between the nib of the pen-shaped body and the panel-contact disc may fracture when subjected to stress.

Taiwanese Utility Model No. M367374 discloses a stylus employing a universal joint configuration between a handle portion and a panel-contact portion for ensuring stable contact between the panel-contact portion and a touch panel during movement of the stylus on the touch panel. However, the panel-contact portion is unable to restore automatically to a normal position relative to the handle portion after use, thereby resulting in inconvenience during the subsequent use.

### SUMMARY OF THE INVENTION

Therefore, an object of the present invention is to provide a stylus that can alleviate the aforesaid drawbacks of the prior art.

According to the present invention, a stylus is adapted for inputting command to an electronic device and comprises an electrically-conductive handle portion, an electrically-conductive contact portion adapted to contact the electronic device, and an electrically-conductive spring. The spring interconnects electrically the handle portion and the contact portion, and is resiliently flexible for permitting the handle portion to pivot relative to the contact portion when the contact portion contacts the electronic device.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view showing a conventional stylus in a state of use;

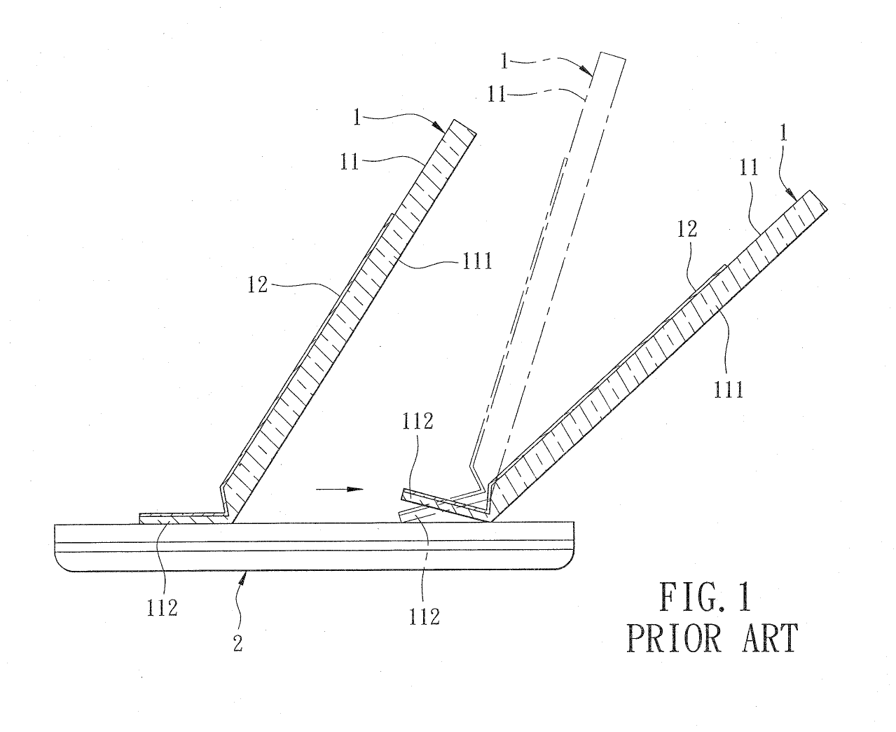

FIG. 2 is a perspective view of a preferred embodiment of a stylus according to the present invention;

FIG. 3 is a top view showing the preferred embodiment being moved on an electronic device;

FIG. 4 is a side view showing the preferred embodiment being moved on the electronic device;

FIG. 5 is a perspective view showing the preferred embodiment partially stored in a cellular phone; and

FIG. 6 is a front view showing the preferred embodiment stored in the cellular phone.

### DETAILED DESCRIPTION OF THE PREFERRED EMBODIMENT

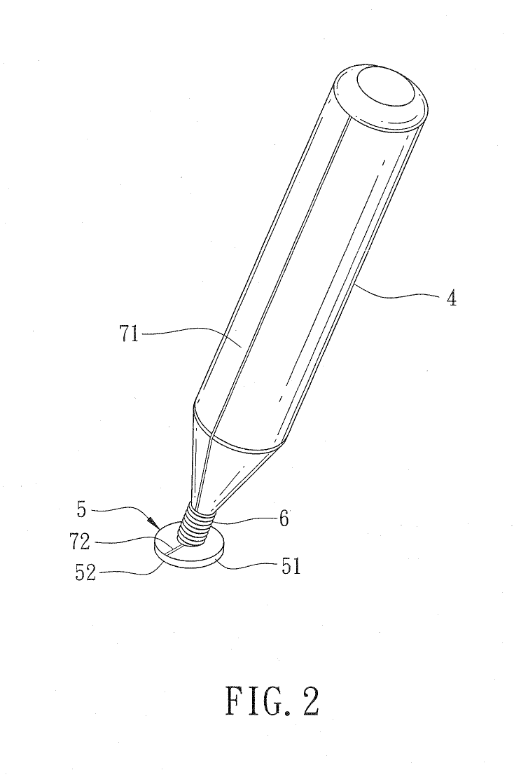

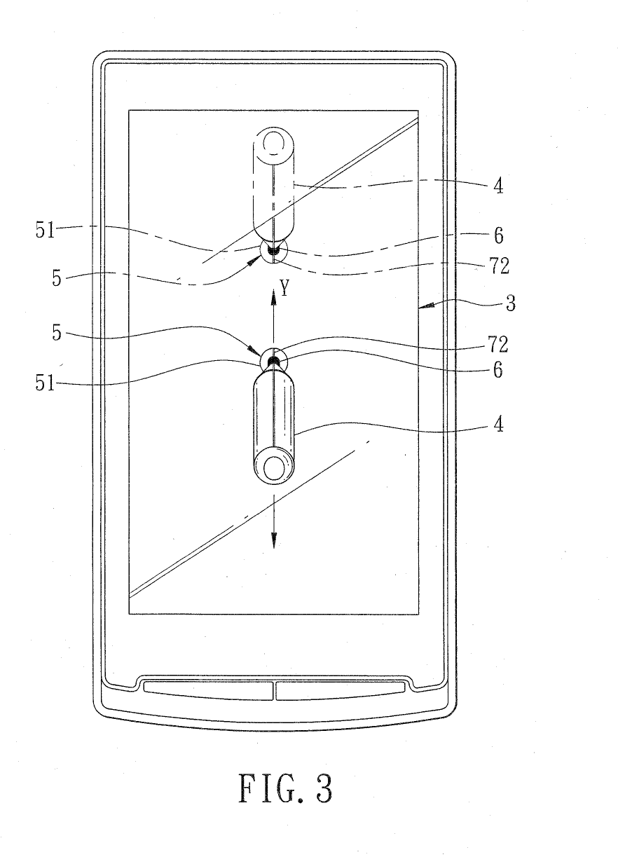

Referring to FIGS. 2 and 3, the preferred embodiment of a stylus of the present invention is adapted for contacting a touch panel 3 of an electronic device and inputting command to the electronic device. The stylus comprises an electrically-conductive handle portion 4, an electrically-conductive contact portion 5, an electrically-conductive spring 6, a first conductive film 71, and a second conductive film 72.

The handle portion 4, made of metal, is formed as a pen in this embodiment, but may be configured to have other shapes, such as a cap, a human figure, an animal figure, a plant figure, and so on.

The contact portion 5 includes a transparent plate 51 formed with a sensing surface 52 that is adapted to contact the touch panel 3 of the electronic device. The transparent plate 51 has a light transmittance greater than 30 percent, and is configured with a dimension larger than 4 square centimeters.

The spring 6 is made of metal and interconnects electrically the handle portion 4 and the contact portion 5. The spring 6 is configured as a coil spring and is flexible for permitting the handle portion 4 to pivot relative to the contact portion 5.

The first conductive film 71 is provided on the handle portion 4. The second conductive film 72 is provided on the transparent plate 51 of the contact portion 5. The spring 6 interconnects electrically the first conductive film 71 and the second conductive film 72.

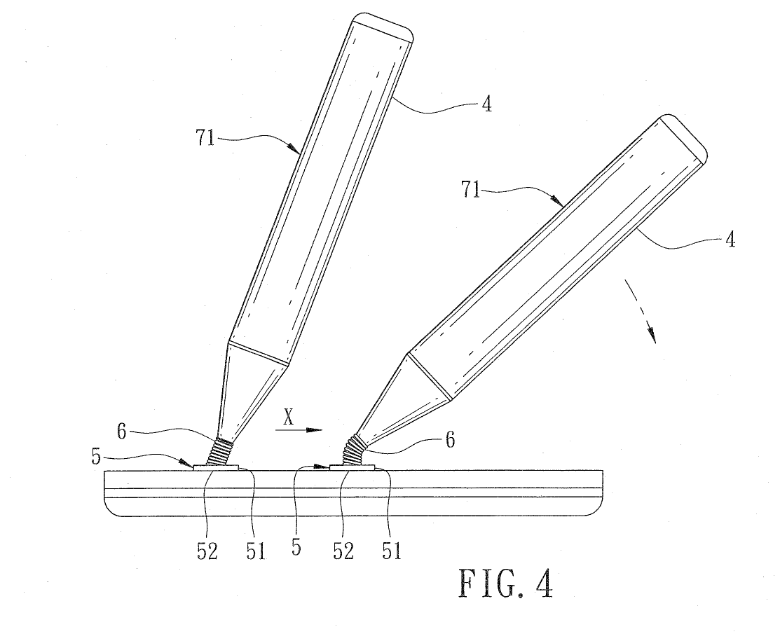

Referring further to FIG. 4, in use, when a user exerts a force on the stylus of the invention to move on the touch panel 3 of the electronic device in different directions, e.g., direction (Y) illustrated in FIG. 3 or another direction (X) illustrated in FIG. 4, the handle portion 4 may form different angles in different orientations relative to the contact portion 5. By virtue of the spring 6, the sensing surface 52 of the contact portion 5 can contact the touch panel 3 stably while the handle portion 4 pivots relative to the contact portion 5. When the exerted force is released, the handle portion 4 can be restored resiliently back to the original state by a restoring force of the spring 6.

It should be noted that the handle portion 4 and the contact portion 5 may be made of a material including electrically-conductive particles and plastic through injection molding.

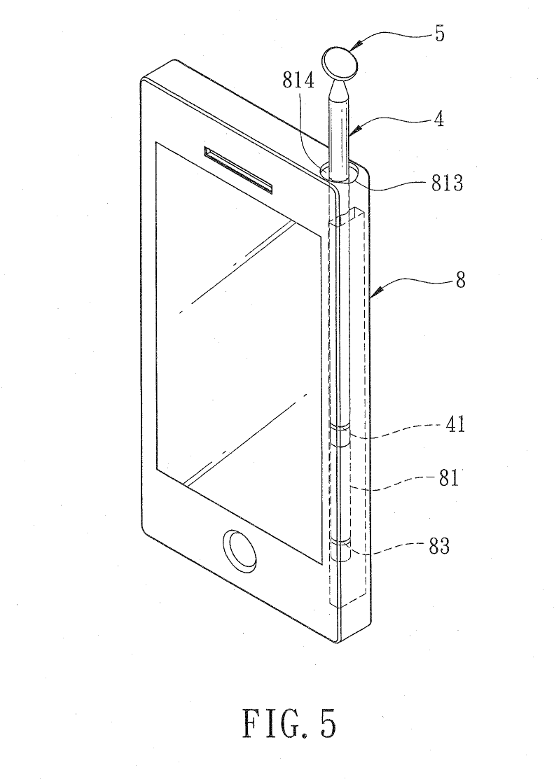

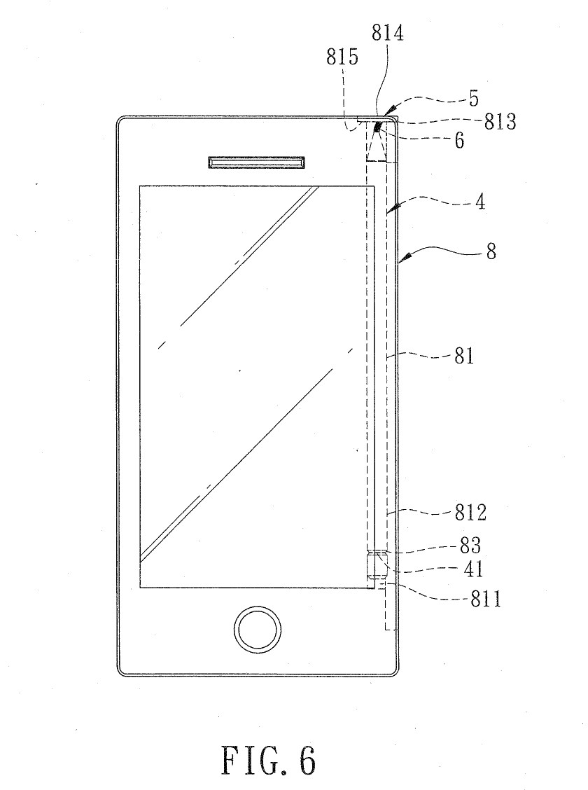

As shown in FIGS. 5 and 6, the stylus of this invention can be stored within an electronic device 8, such as a cellular phone, after use. The handle portion 4 is formed with an annular groove 41 thereon.

The electronic device 8 has a stylus hole 81 formed in a side thereof. The stylus hole 81 has a small-diameter hole portion 811 defined by an inner surface 812, a large-diameter hole portion 813 having an opening 814, and a shoulder portion 815 disposed between the small-diameter hole portion 811 and the large-diameter hole portion 813. The inner surface 812 is formed with a protrusion 83.

In use, the handle portion 4 can be inserted into the stylus hole 81 via the opening 814 and positioned within the stylus hole 81 through engagement between the protrusion 83 and the annular groove 41. Since the contact portion 5 is pivotable relative to the handle portion 4, the contact portion 5 can abut properly against the shoulder portion 815 so as to be retained entirely in the large-diameter hole portion 813 of the stylus hole 81.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A stylus adapted for inputting command to an electronic device, comprising:
an electrically-conductive handle portion;
an electrically-conductive contact portion adapted to contact the electronic device; and
an electrically-conductive spring interconnecting electrically said handle portion and said contact portion, said spring being resiliently flexible for permitting said handle portion to pivot relative to said contact portion when said contact portion contacts the electronic device.

2. The stylus as claimed in claim 1, further comprising a first conductive film that is provided on said contact portion and that is connected electrically to said spring.

3. The stylus as claimed in claim 2, further comprising a second conductive film that is provided on said handle portion and that is connected electrically to said spring.

4. stylus as claimed in claim 1, wherein said handle portion is made of metal.

5. The stylus as claimed in claim 3, wherein said handle portion is made of metal.

6. The stylus as claimed in claim 1, wherein said handle portion and said contact portion are made of a material including electrically-conductive particles and plastics.

7. The stylus as claimed in claim 6, wherein said spring is made of metal.

8. The stylus as cl aimed in claim 1, wherein said spring is made of metal.

9. The stylus as claimed in claim 1, wherein said contact portion includes a transparent plate formed with a sensing surface adapted to contact the electronic device.

10. The stylus as claimed in claim 9, wherein said transparent plate has a light transmittance greater than 30 percent.
